(19) United States
(12) Patent Application Publication
(10) Pub. No.: US 2020/0021917 A1
(43) Pub. Date: Jan. 16, 2020

(54) SPEAKER

(71) Applicant: Sung Soo LEE, Cheongju-si (KR)

(72) Inventor: Sung Soo LEE, Cheongju-si (KR)

(21) Appl. No.: 16/471,504

(22) PCT Filed: Aug. 23, 2017
(86) PCT No.: PCT/KR2017/009219

§ 371 Date: Jun. 19, 2019

(30) Foreign Application Priority Data
Dec. 20, 2016 (KR) 10-2016-0174838
Mar. 6, 2017 (KR) 10-2017-0028266

(51) Int. Cl. H04R 9/04; H04R 9/02; H04R 7/16; H04R 1/02; H04R 7/04; H04R 23/02; H04R 9/06; H04R 11/02

(52) U.S. Cl. CPC H04R 9/045; H04R 9/025; H04R 7/16; H04R 1/02; H04R 2307/027; H04R 23/02; H04R 9/06; H04R 11/02; H04R 2201/02; H04R 7/04

(57) ABSTRACT

The present invention relates to a speaker. A speaker according to the present invention includes: a pair of permanent magnets arranged on both empty side surfaces of a solenoid coil formed in a rectangular container shape, and first and second setting cases configured to set the locations of the solenoid coil and the permanent magnets or to minimize leakage flux. In a fabrication step according to the present invention, the locations of the solenoid coil and the permanent magnets can be accurately set, and thus an advantage arises in that manufacturing efficiency is improved.

### TECHNICAL FIELD

The present invention relates to a speaker.

### BACKGROUND ART

Solenoid coil speakers are classified into dynamic speakers and armature speakers.

A dynamic speaker is a moving coil-type speaker, and includes a permanent magnet, a coil, and a diaphragm configured to vibrate in response to the movement of the coil. In other words, when current flows through the coil, the coil vibrates due to the influence of a magnetic field formed by the permanent magnet, and thus the diaphragm vibrates in response to the vibration of the coil, thereby generating sound.

An armature speaker includes a permanent magnet, a coil, an armature configured to be magnetized by current flowing through the coil, a drive rod connected to the armature, and a diaphragm configured to vibrate in response to the vibration of the drive rod. In other words, when current flows through the coil, the armature is magnetized and vibrates due to the influence of a magnetic field formed by the permanent magnet, and thus the drive rod and the diaphragm vibrate together, thereby generating sound.

In general, a dynamic speaker and an armature speaker have the following relative advantages and disadvantages.

A dynamic speaker is simple in structure, low in cost because the level of requirements for the performance of components is low, easy to turn, and easy to fabricate because the diameter of the speaker is large. In contrast, a dynamic speaker has a weakness in the implementation of sophisticated sound quality because a vibration system includes the weight of the coil, and has its limitation on reducing the size thereof in that the length and moving distance of the coil need to be sufficiently secured.

An armature speaker can implement sophisticated sound quality because a vibration system is independent of the weight of the coil. In contrast, an armature speaker requires high manufacturing cost because the level of requirement for the performance of components, such as an armature involved in the magnetic interference between the coil and the magnet, is high and it is difficult to manufacture the speaker.

Meanwhile, an attempt has been made to combine the advantages of a dynamic speaker and an armature speaker. The technology (hereinafter referred to as “prior art”) of Korean Utility Model Registration No. 20-0404313 (title of the device: Speaker) makes use of a pair of plates for the magnetic interference between a coil and a magnet. However, the prior art has the following problem in that the plates are used for the magnetic interference between the coil and the magnet.

As can be seen from FIG. 6, the magnetic flux converged on plates P1 and P2 having a small thickness has a narrow width and is not uniform due to an edge effect, and thus a coil C placed therebetween is not subjected to linear magnetic force while vibrating in vertical directions. The density of lines MF of magnetic force in a space where the coil C vibrates is concentrated toward a magnet M and is strong while the density of lines MF of magnetic force in an upper portion opposite to the magnet M is low and weak. Therefore, it is difficult to balance the upward and downward vibration forces of the coil, and thus the property of implementation of excellent sound quality is degraded to that extent.

### DISCLOSURE

### Technical Problem

Objects of the present invention are as follows:

First, there is provided technology that can precisely set the relative locations of magnets and a coil when an actual solenoid coil speaker is fabricated.

Second, there is provided technology that can minimize the leakage of lines of magnetic force.

Third, there is provided technology that can maximize the amplitude of a diaphragm.

### Technical Solution

In order to accomplish the above objects, according to a first aspect of the present invention, there is provided a speaker including: a solenoid coil formed in a rectangular container shape having both open sides; two permanent magnets provided on both the open sides of the solenoid coil, and arranged such that the opposite surfaces of the two permanent magnets have different poles; first and second setting cases configured to set the locations of the solenoid coil and the two permanent magnets; a diaphragm provided above the solenoid coil; a drive rod configured such that the lower end thereof is coupled to the upper portion of the solenoid coil and the upper end thereof is fastened to the diaphragm; a circuit board configured to provide an electric signal to the solenoid coil; and an outer case configured to surround the individual components; wherein the upper portion of the solenoid coil is located between the two permanent magnets so that the upper portion of the solenoid coil is located in a magnetic field where the density of lines of magnetic force generated by the two permanent magnets is uniform and linear, and wherein the first setting case has a first location setting protrusion configured to set the locations of the solenoid coil and the two permanent magnets, and the second setting case has a second location setting protrusion configured to set the locations of the two permanent magnets.

The second setting case may further have a through hole configured to pass the drive rod therethrough.

The first and second setting cases may be made of a magnetic material, and may form a magnetic circuit.

In order to accomplish the above objects, according to a second aspect of the present invention, there is provided a speaker including: a solenoid coil formed in a rectangular container shape having both open sides; two permanent magnets provided on both the open sides of the solenoid coil, and arranged such that the opposite surfaces of the two permanent magnets have different poles; first and second setting cases configured to set the locations of the solenoid coil and the two permanent magnets; a diaphragm provided above the solenoid coil; a drive rod configured such that the lower end thereof is coupled to the upper portion of the solenoid coil and the upper end thereof is fastened to the diaphragm; and a circuit board configured to provide an electric signal to the solenoid coil; wherein the first and second setting cases are made of a magnetic material, and form a magnetic circuit.

The first setting case may have support walls configured to come into contact with the two permanent magnets at both ends thereof.

The first and second setting cases may have spacing portions configured to space at least the upper and lower ends of the two permanent magnets apart from the magnetic material portions of the first and second setting cases.

The length of the two permanent magnets may be shorter than the length of the solenoid coil.

In order to accomplish the above objects, according to a third aspect of the present invention, there is provided a speaker including: a solenoid coil formed in a rectangular container shape having both open sides; two permanent magnets provided on both the open sides of the solenoid coil, and arranged such that the opposite surfaces of the two permanent magnets have different poles; first and second setting cases configured to set the locations of the solenoid coil and the two permanent magnets; a diaphragm provided above the solenoid coil; a drive rod configured such that the lower end thereof is coupled to the upper portion of the solenoid coil and the upper end thereof is fastened to the diaphragm; and a circuit board configured to provide an electric signal to the solenoid coil; wherein the length of the two permanent magnets is shorter than the length of the solenoid coil.

### Advantageous Effects

According to the present invention, the following effects are achieved:

First, the locations of the solenoid coil and the permanent magnets are precisely set by the first and second setting cases, and thus the present invention is convenient for fabrication.

Second, when the first and second setting cases are made of a magnetic material, the leakage of magnetic flux can be minimized.

Third, the upper and lower ends of the permanent magnets are spaced apart from the first and second setting cases, and thus the density of magnetic flux passing through the upper end of the solenoid coil can be increased.

Fourth, the length of the permanent magnets is made to be shorter than the length of the solenoid coil, and thus the vibration amplitude of the upper end of the coil can be maximized, thereby improving sound output.

### DESCRIPTION OF DRAWINGS

FIG. 1 is a perspective view of a speaker according to an embodiment of the present invention;

FIG. 2 is a cutaway view of the speaker of FIG. 1 taken along line A-A;

FIG. 3 is a cutaway view of the speaker of FIG. 1 taken along line B-B;

FIG. 4 is an exploded perspective view of the characteristic internal components of the speaker of FIG. 1;

FIG. 5 is a reference view showing a magnetic circuit in the speaker of FIG. 1;

FIG. 6 is a reference view illustrating the problem of the prior art; and

FIG. 7 is a reference view illustrating a problem in terms of the arrangement of a permanent magnet and a solenoid coil in a solenoid coil speaker.

### MODE FOR INVENTION

Preferred embodiments of the present invention will be described in detail below with reference to the accompanying drawings.

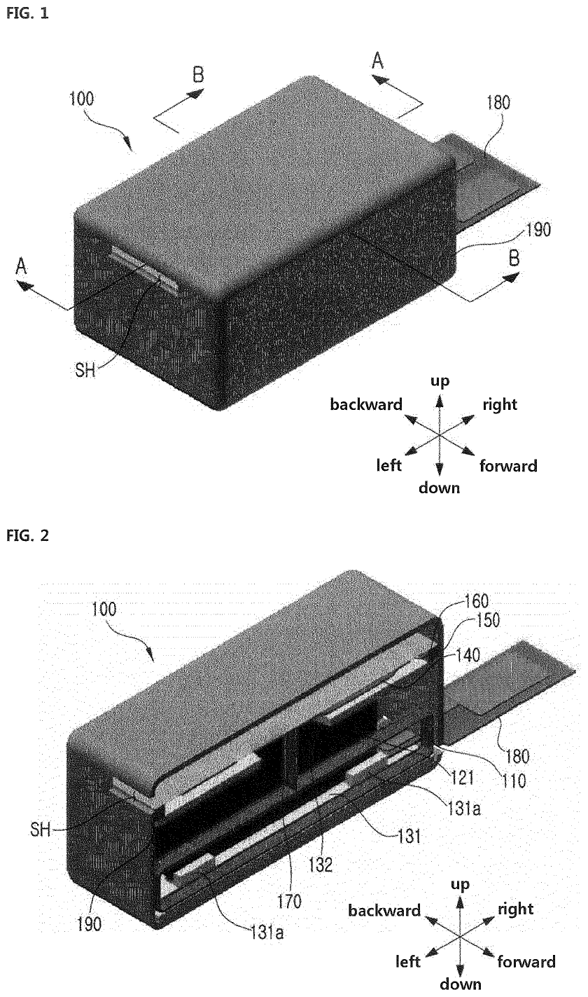

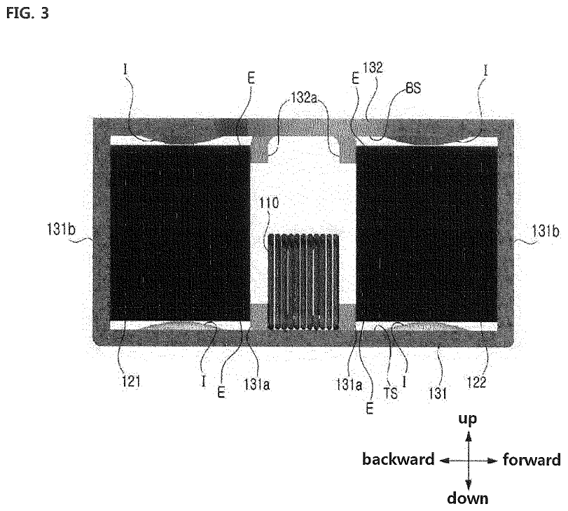

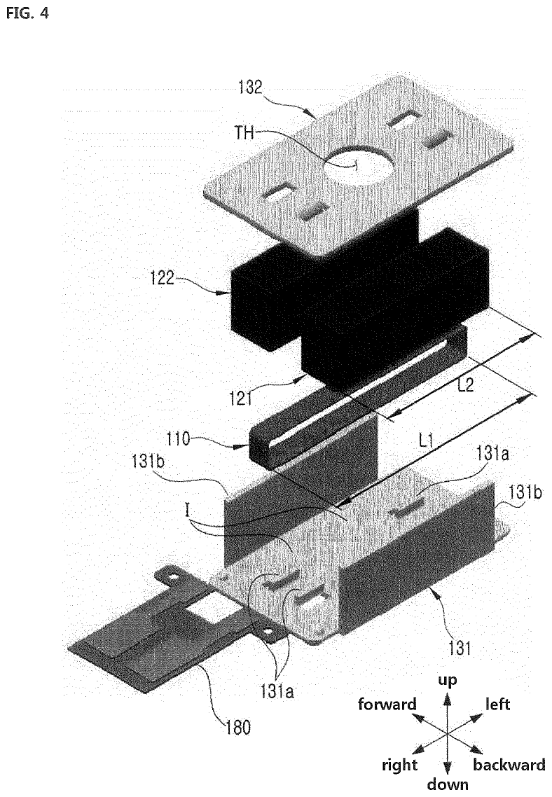

FIG. 1 shows a speaker 100 according to an embodiment of the present invention. Furthermore, FIG. 2 is a cutaway view of the speaker 100 of FIG. 1 taken along line A-A, FIG. 3 is a cutaway view of the speaker 100 of FIG. 1 taken along line B-B, and FIG. 4 is an exploded perspective view of the characteristic internal components of the speaker 100.

The speaker 100 according to the embodiment of the present invention includes a solenoid coil 110, a pair of permanent magnets 121 and 122, first and second setting cases 131 and 132, a diaphragm 140, a fastening frame 150, a vibration film 160, a drive rod 170, a circuit board 180, and an outer case 190.

The solenoid coil 110 has an empty internal space, and is formed in a rectangular container shape having both open sides. The upper end of the solenoid coil 110 is provided such that current flows in a direction perpendicular to the direction of lines of magnetic force that are formed by the pair of permanent magnets 121 and 122.

The first and second setting cases 131 and 132 are provided to set the locations of the solenoid coil 110 and the pair of permanent magnets 121 and 122.

The first setting case 131 has first location setting protrusions 131a formed to grip the lower end of the solenoid coil 110 in the middle thereof, and support walls 131b configured such that the inner surfaces thereof come into contact with the permanent magnets 121 and 122, respectively, are formed to be long at the left and right ends thereof in vertical directions.

The second setting case 132 also has second location setting protrusions 132a configured to grip the upper end of the solenoid coil 110 in the middle thereof. Furthermore, a through hole TH configured to allow the drive rod 170 to be installed through the second setting case 132 is formed through the second setting case 132.

According to the above-described configuration, as can be seen from FIG. 3, the location of the solenoid coil 110 may be accurately set by the first location setting protrusions 131a of the first setting case 131, and the locations of the pair of permanent magnets may be accurately set by the first location setting protrusions 131a, the second location setting protrusions 132a, and both the support walls 131b.

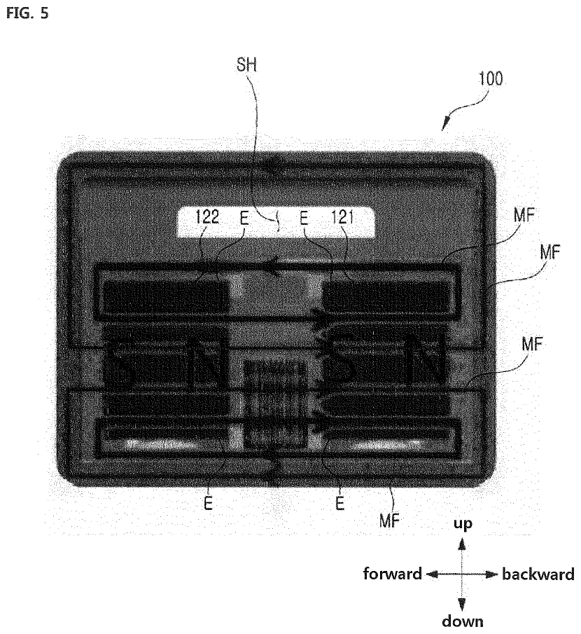

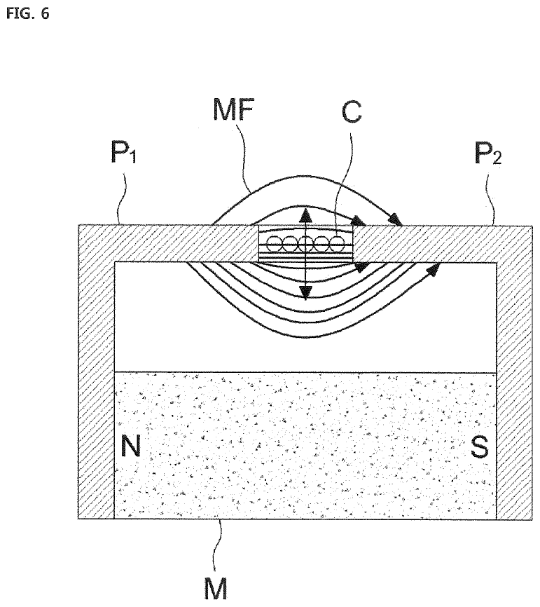

Furthermore, it is preferable that the first and second setting cases 131 and 132 be made of a magnetic material and the first and second location setting protrusions 131a and 132a be made of a non-magnetic material. Accordingly, as can be seen from the lines MF of magnetic force of FIG. 5, as the first and second setting cases 131 and 132 form a magnetic circuit, the lines of magnetic force are formed to maximally pass over the solenoid coil 110 in the state of being confined without leaking to the outside, thereby increasing vibration force and thus improving output.

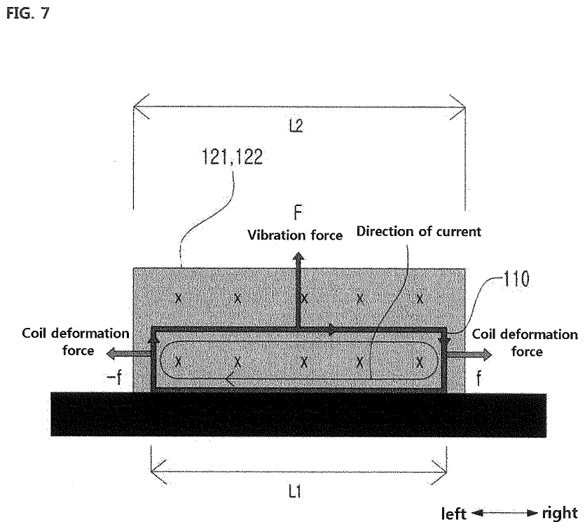

Furthermore, the first and second setting cases 131 and 132 have spacing portions I configured to space the upper and lower ends E of the permanent magnets 121 and 122 from the bottom surface BS of the first setting case 131 and the top surface TS of the second setting case 132 so that the lines of magnetic force, such as those of FIG. 5, are formed. For reference, an uniform magnetic field area between the permanent magnets 121 and 122 may be widened by spacing the upper and lower ends E of the permanent magnets 121 and 122 apart from magnetic material portions via the spacing portions I. These spacing portions I may be formed to protrude in a convex form by press work, or may be provided by adding separate spacing members. It will be apparent that in the case where the first and second setting cases 131 and 132 are not made of a magnetic material, it is not necessary to provide the spacing members. Furthermore, even in the case where the first and second setting cases 131 and 132 are made of a magnetic material, when characteristics required according to the type of speaker 100 are sufficiently implemented, having a structure in which the upper and bottom surfaces of the permanent magnets 121 and 122 come into contact with the first and second setting cases 131 and 132 without providing the separate spacing portions I may be preferably considered. For reference, in FIG. 7, sign “x” refers to the direction of a magnetic field.

The diaphragm 140 is provided to generate sound through vibration. This diaphragm 140 has a thin rectangular plate shape made of a metallic material, such as aluminum. In the present embodiment, the speaker is formed in a hexahedral shape, and thus the diaphragm 140 is formed in a rectangular plate shape. The diaphragm 140 is provided in a shape corresponding to the overall shape of the speaker 100. Accordingly, only the diaphragm 140 having a rectangular plate shape should not be construed as being applied to the speaker 100 according to the present invention.

The fastening frame 150 is provided to fasten the diaphragm to the outer case 190. This fastening frame 150 has a rectangular frame shape, and thus the diaphragm 140 may be provided inside the fastening frame 150. It will be apparent that the fastening frame 150 may be fabricated in various shapes as long as the diaphragm 140 can be provided inside the fastening frame 150.

The vibration film 160 is made of a flexible material in order to perform the edge function of the speaker 100. The diaphragm 140 is attached to the vibration film 160, and the edges of the vibration film 160 are attached to the fastening frame 150, thereby causing the diaphragm 140 to be ultimately fastened to the outer case 190.

The lower end of the drive rod 170 is attached and coupled to the center portion of the top of the solenoid coil 110, and the upper end thereof is fastened to the diaphragm 140. In this case, the drive rod 170 is passed and installed through the through hole TH of the second setting case 132. It will be apparent that the drive rod 170 may be integrated with the diaphragm 140.

The circuit board 180 provides an electric signal to the solenoid coil.

The outer case 190 accommodates and surrounds the above-described components, and a sound hole SH configured such that the sound generated by the diaphragm 140 is emitted therethrough is formed through the outer case 190.

Meanwhile, according to the present invention, the length L2 of the permanent magnets 121 and 122 in a lateral direction is provided to be shorter than the length L1 of the solenoid coil 110 in a lateral direction. Accordingly, the force applied to the left and right ends of the solenoid coil 110 from the outside by the magnetic field of the permanent magnets 121 and 122 is eliminated, and thus the upper end of the solenoid coil 110 may vibrate at a higher amplitude, resulting in an increase in the magnitude of generated sound.

For reference, if the length L2 of the permanent magnets 121 and 122 in the lateral direction is longer than or equal to the length L1 of the solenoid coil 110 in the lateral direction, as shown in FIG. 7, coil deformation forces (f, and −f) appear on the left and right sides of the solenoid coil 110 according to Fleming's left-hand rule. Accordingly, vibration force F given to the upper end of the solenoid coil 110 is weakened, and thus the amplitude of the upper end of the solenoid coil 110 is reduced, thereby causing a problem in which sound output is decreased.

Next, the operation of the above-described speaker 100 will be described.

When an electric signal is input to the solenoid coil 110 via the circuit board 180, the upper portion of the solenoid coil 110 is subjected to magnetic force based on Fleming's left-hand rule. Accordingly, as the upper portion of the solenoid coil 110 is slightly deformed, vibration is generated in vertical directions. Accordingly, the drive rod 170 vibrates in vertical directions, and ultimately the diaphragm 140 vibrates in vertical directions. As a result, sound is generated.

Meanwhile, even during assembly work, the locations of the solenoid coil 110 and the permanent magnets 121 and 122 are accurately set by the first and second setting cases 131 and 132, and thus the speaker may be easily fabricated without requiring a separate jig or the like.

As described above, although the present invention has been described in detail by means of the embodiments described with reference to the accompanying drawings, the above-described embodiments have been described as preferred examples of the present invention. Accordingly, the present invention should not be construed as being limited only to the above-described embodiments, but the scope of the present invention should be construed as encompassing the following claims and concepts equivalent to the claims.

1. A speaker comprising:
a solenoid coil formed in a rectangular container shape having both open sides;
two permanent magnets provided on both the open sides of the solenoid coil, and arranged such that opposite surfaces of the two permanent magnets have different poles;
first and second setting cases configured to set locations of the solenoid coil and the two permanent magnets;
a diaphragm provided above the solenoid coil;
a drive rod configured such that a lower end thereof is coupled to an upper portion of the solenoid coil and an upper end thereof is fastened to the diaphragm;
a circuit board configured to provide an electric signal to the solenoid coil; and
an outer case configured to surround the individual components;
wherein the upper portion of the solenoid coil is located between the two permanent magnets so that the upper portion of the solenoid coil is located in a magnetic field where a density of lines of magnetic force generated by the two permanent magnets is uniform and linear; and
wherein the first setting case has a first location setting protrusion configured to set locations of the solenoid coil and the two permanent magnets, and the second setting case has a second location setting protrusion configured to set locations of the two permanent magnets.

2. The speaker of claim 1, wherein the second setting case further has a through hole configured to pass the drive rod therethrough.

3. The speaker of claim 1, wherein the first and second setting cases are made of a magnetic material, and form a magnetic circuit.

4-8. (canceled)

9. The speaker of claim 1, wherein the first setting case has support walls configured to come into contact with the two permanent magnets at both ends thereof.

10. The speaker of claim 9, wherein the first and second setting cases have spacing portions configured to space at least upper and lower ends of the two permanent magnets apart from magnetic material portions of the first and second setting cases.

11. The speaker of claim 1, wherein a length of the two permanent magnets is shorter than a length of the solenoid coil.

12. A speaker comprising:
a solenoid coil formed in a rectangular container shape having both open sides;
two permanent magnets provided on both the open sides of the solenoid coil, and arranged such that opposite surfaces of the two permanent magnets have different poles;
first and second setting cases configured to set locations of the solenoid coil and the two permanent magnets;
a diaphragm provided above the solenoid coil;
a drive rod configured such that a lower end thereof is coupled to an upper portion of the solenoid coil and an upper end thereof is fastened to the diaphragm;
a circuit board configured to provide an electric signal to the solenoid coil; and
wherein the first and second setting cases are made of a magnetic material, and form a magnetic circuit.

13. The speaker of claim 12, wherein the first setting case has support walls configured to come into contact with the two permanent magnets at both ends thereof.

14. The speaker of claim 13, wherein the first and second setting cases have spacing portions configured to space at least upper and lower ends of the two permanent magnets apart from magnetic material portions of the first and second setting cases.

15. The speaker of claim 12, wherein a length of the two permanent magnets is shorter than a length of the solenoid coil.

16. A speaker comprising:
a solenoid coil formed in a rectangular container shape having both open sides;
two permanent magnets provided on both the open sides of the solenoid coil, and arranged such that opposite surfaces of the two permanent magnets have different poles;
first and second setting cases configured to set locations of the solenoid coil and the two permanent magnets;
a diaphragm provided above the solenoid coil;
a drive rod configured such that a lower end thereof is coupled to an upper portion of the solenoid coil and an upper end thereof is fastened to the diaphragm;
a circuit board configured to provide an electric signal to the solenoid coil; and
wherein a length of the two permanent magnets is shorter than a length of the solenoid coil.
